(19) United States
(12) Patent Application Publication
(10) Pub. No.: US 2003/0134106 A1
(43) Pub. Date: Jul. 17, 2003

(54) Polyolefin film for use as a non-staining masking film

(76) Inventors: Rengarajan Ramesh, Bath, OH (US); Tien Tjiu Tan, East Java (ID)

Correspondence Address: THE FIRM OF HUESCHEN AND SAGE, 500 COLUMBIA PLAZA, 350 EAST MICHIGAN AVENUE, KALAMAZOO, MI, 49007, US

(21) Appl. No.: 10/314,740

(22) Filed: Dec. 9, 2002

Related U.S. Application Data
(63) Continuation of application No. 09/707,193, filed on Nov. 6, 2000, now abandoned.

(51) Int. Cl. B32B 3/00

(52) U.S. Cl. 428/323; 106/400; 523/352; 428/166

(57) ABSTRACT

Synthetic polyolefin films of one or more layers, wherein each layer may be of a different thickness and a different formulation. The films consist of a polyolefin resin and a suitable mineral filler of at least three microns in particle size. The films are particularly useful as a masking material in paint overspray protection systems and may be used to protect a finished surface from moisture and/or ultraviolet radiation. The films posses the advantage that their use does not result in staining or ghosting on the protected or masked surface.

### FIELD OF THE INVENTION

The instant invention relates to synthetic plastic film which possess advantageous mechanical properties such as liquid and gas permeability, moisture resistance, as well as the texture and tear performance characteristics of cellulose type paper. The film is designed for use as a masking material in painting technology and is particularly effective because it does not stain a masked surface or cause “ghosting”. The film may also be used for masking or protecting a painted surface. More specifically, the invention refers to a single or multilayer synthetic plastic film comprising a polyolefin carrier resin and a mineral filler. Film may be prepared either in a blown film or cast film process. Preferably, the invention pertains to a multi-layer film in which the mineral content and film thickness are varied between the multiple layers.

### PRIOR ART

Polyolefin films are well known in the art, have been used for numerous purposes, and are made according to various formulations. Specifically in painting technology, polyolefin films are used as masking material to block paint overspray. Polyolefin films are also utilized as protectant films covering delicate surfaces. Examples of products currently on the market are ordinary traditional masking paper, masking film protection, polyethylene based sheets for automotive and construction applications, drop cloth sheets.

Polyolefin films are advantageous in this role over conventional paper based masking because they are durable and moisture resistant. Unfortunately, polyolefin films do not come without disadvantages, primary of which is staining. Staining or ghosting is a phenomenon in painting technology wherein, during the process of drying a painted surface, there is an uneven drying rate due to uncontrolled humidity in the environment. When a painted surface, which is not fully set or not fully dried, is being baked or dried at different temperatures and at humidity levels between 30% up 95%, staining or ghosting may appear on the painted surface. These marks are not removable by wiping. It has also been observed that a polyolefin film can trap water against a clear coated surface. Under exposure to heat or ultraviolet light, the clear coat absorbs water, can become soft, and exhibits a hazy appearance. This appearance does not dissipate upon drying. With either situation, the surface must be repainted, which is costly.

For example, if a vehicle is covered with a synthetic plastic film for protection from the elements during shipping before its painted surfaces have had a chance to fully dry, ghosting may occur. This is caused by the fact that the inside surface of a film adheres to the finished or painted surface to varying degrees. The presence of residual solvents and/or humidity or water vapor also causes the masking to adhere to varying degrees. The uneven contact with the painted surface in turn affects the drying rate itself. This variation in adhesion affects the drying rate and results in ghosting or staining. Thus, the existence of variation in humidity, temperature, and lighting will cause ghosting or staining on a masked surface.

In an effort to overcome these obstacles, attempts have been made to pattern the surface of the polyolefin film. This patterning or embossing has been shown to provide the necessary breathability to masking material, that prevents ghosting. However, there are drawbacks to embossing. The masked surface, while free from ghosting, adopts the pattern embossed on the masking material. This pattern is visible to the naked eye and is considered a disadvantage to the use of polyolefin masking.

The embossing process is an expensive process given that the pattern must be made with an additional embossing roller. This technique is not entirely effective because embossing depth will be significantly reduced as the embossed film is wound in a roll. In a single wound sheet or even in tubular film, the deeper into the reel or the closer to core, the less depth to the pattern and thus the less effective the stain or ghost prevention. Embossing can only be used as a means to enhance non-staining properties, but not to eliminate them in a stable or consistent manner.

Another option to reduce ghosting or staining is to increase the particle size of the mineral filler. This has been attempted with varying degrees of success. Obstacles include the tendency of the polyolefin film or bubble structure to burst or break due to the inherent imperfections of the mineral filler. In an effort to avoid these difficulties, processors are forced to limit particle size and to slow the run speed for film processing. Japanese Unexamined Application Publication Numbers 10-80949 and 10-193454 show a particle size limited to 1.7 micron and a run speed of 20 m/minute.

Finally, there is a concern that increased particle size increases the incidence of scratching the paint of the masked surface. End consumers request a smooth film with no hard material on the film surface.

### OBJECTS OF THE INVENTION

The present invention covers the development of a mono layer and preferably a three or more layer synthetic plastic film which can be used as a replacement for masking paper which is used in paint overspray protection systems and generally for use as a replacement for conventional protective films. The synthetic plastic film comprises a Polyalkylene or more specifically a Polyolefin (LDPE, LLDPE, MDPE, Metallocene LLDPE, HDPE, Random Copolymer PP, or Block Copolymer PP) as the carrier resin and a mineral filler. The film may be structured in a monolayer or, preferably, in three or more layers. Film is manufactured in a monolayer or, preferably, in a multi-layer blown or a multi-layer cast film process, and the rheology of the carrier resin can be varied to accommodate the type of film extrusion process.

The filler levels in the formula can range from 5 percent to 60 percent by weight in the formulation with particle sizes in excess of thirty percent of the total film thickness. The mineral filler can be one or a combination of the following substances: Calcium Carbonate, Aluminum Silicate (clay), Magnesium Silicate, and Calcium Silicate (Wollastonite).

Advantageously, the film structure can be a co-extruded structure where the number of layers can be from three layers to seven layers. Once again, these multi-layer structures can be manufactured either in a blown film or a cast film process. This configuration allows each layer to have a different composition of material and thickness. In addition, this material can be coextruded with conductive material, anti-static material, flame retardant, and/or colorant.

This invention also covers the lamination (either adhesive or extrusion lamination) of the synthetic plastic film with any other substrate to achieve similar paperlike feel in the laminate. Such material has a paperlike feel and behavior while retaining the advantages of the polyolefin derived product. If the advantages of the present films are combined with woven polypropylene to get different properties, the paperlike feel is retained along with the additional features associated with the new laminates, including better strength and better breathability.

This invention also covers the process of extrusion coating of the instant synthetic plastic film on either a paper or polymer film structure to achieve a paperlike feel in the laminate. The laminates that can be used are woven material made of PP and HDPE to get strength as well as breathability.

### SUMMARY OF THE INVENTION

What we believe to be our invention, then, inter alia, comprises the following, singly or in combination:

A synthetic plastic film of one or more layers particularly suitable for masking or protecting a painted surface without causing staining or ghosting, comprising a polyolefin carrier resin and at least 5 percent by weight of a mineral filler, wherein the mineral filler has a particle size of at least 3 microns, which film can be generated by a blown or cast method at high speeds; such a

a synthetic plastic film wherein the polyolefin carrier resin consists of at least one polyolefin which is a linear or branched alpha olefin with a molecular weight of between 1000 and 1000000; such a

synthetic plastic film wherein the polyolefin carrier resin is selected from the group consisting of LDPE, LLDPE, MDPE, HDPE, Metallocene LLDPE, random copolymer PP, block copolymer PP, and homopolymer PP; such a

synthetic plastic film wherein the polyolefin carrier resin may be a single polyolefin or a blend of two or more polyolefins; such a

synthetic plastic film wherein the mineral filler is selected from the group consisting of calcium carbonate, dolomite, magnesium silicate, and clay; such a

calcium carbonate mineral filler which contains calcium carbonate, magnesium carbonate, and iron carbonate; such a

dolomite mineral filler which contains calcium carbonate, magnesium carbonate, aluminum carbonate, and iron carbonate; such a

magnesium silicate mineral filler which contains silicon oxide, magnesium oxide, iron oxide, and calcium oxide; such a

clay mineral filler which contains aluminum oxide, silicon oxide, magnesium oxide, potassium oxide, sodium oxide, and iron oxide; such a

synthetic plastic film wherein the mineral filler comprises up to 5 percent by weight of the total film weight; such a

synthetic plastic film wherein the mineral filler comprises up to 10, 20, 40, or 60 percent by weight of the total film weight; and such a

synthetic plastic film wherein the mineral filler particle size is up to 30, 40, or 50 percent of the total film thickness.

Moreover, a synthetic plastic film wherein a multilayer film is coextruded; such a

multilayer film which consists of three, five, or seven layers; and such a

multilayer film wherein each layer may have a different formulation, and wherein each layer may have a different thickness.

Further, a multilayer film in which the synthetic plastic film is coextruded with a conductive material; such a

multilayer film in which the synthetic plastic film is coextruded with an antistatic material; such a

multilayer film in which the synthetic plastic film is coextruded with a flame-retardant material; such a

multilayer film in which the synthetic plastic film is coextruded with a colorant; such a

multilayer film in which the synthetic plastic film is coextruded with a matte paperlike resin composition; such a

multilayer film in which the synthetic plastic film is coextruded with a synthetic paper composition; such a

multilayer film in which the synthetic plastic film is coextruded with a styrene butadiene copolymer; and such a

multilayer film in which the synthetic plastic film is coextruded with a polyamide 6 and/or 6.6 and/or 12.

Also a synthetic plastic film wherein a monolayer film is extruded; and, finally,

A synthetic plastic film that, when applied to a painted surface protects against paint overspray, moisture, and ultraviolet damage to the painted surface without staining or ghosting the surface and without leaving a pattern on the surface.

### IN GENERAL

In general, the components of the synthetic plastic film of the present invention are admixed together using standard mixing practices, as in and through a Banbury™ or other suitable extruder, e.g., a twin-screw extruder, for enhancing complete admixture of the components and to give a homogenous dispersion of the components throughout the film. The synthetic film composition consists of premixed material, that is then further gravimetrically blended by a computer—assisted method or a manual method. Fillers are compounded first as they require a different screw design to obtain uniform granules. Filler granules are then further gravimetrically mixed either by a computer-assisted method or by a manual method to obtain the desired property. Each layer may have different blends and each will require a separate gravimetric blend of material.

In the case of multilayer blown films, the assembly must have a suitable material inlet, correct screw design with enough pressure and shear rate, good cooling at the feed zone with a grooved barrel, and tungsten carbide inserts to maintain screw life and barrel life, resulting in product consistency.

The die design needs to have a good low pressure profile while being able to be run with average output from 400 kg/hour on 225-250 mm diameter die. In the case of a cast film, the average output can run about 700 kg/hour on a T die width of 1800 mm.

The principle is similar as additional layers are added. Each screw will be conditioned depending on the material used to get additional property enhancement.

The film composition can vary from layer to layer. For example, a paperlike film, having a good tensile property along with a barrier property, may be prepared.

Different ingredients may be put on each extruder to obtain the desired property for each layer.

The components employed according to the present invention are well known in the art and their composition and manufacture do not constitute any part of the present invention, except as the proportions may or may not effect the desirable properties in the ultimate film.

The synthetic plastic film composition of the present invention may additionally contain, as required, various additives such as antioxidants, coupling agents, UV absorbers, light protectants, heat-resistant stabilizers, pigments, dyes, and the like in minor proportions, e.g., up to a total of ten percent of the total weight of the film, although ordinarily not more than about five percent of the total weight of the film, and usually not more than one or two percent by weight of the total blend. Processing stabilizers and color concentrates are available in the trade and may be employed if desired.

The starting materials for the synthetic plastic film of the present invention comprise about 30-95 parts by weight of a polyolefin resin, and about 5-70 parts by weight of a mineral filler. Such raw materials are readily available on the open market. For example, the polyalkylene resin can advantageously comprise a unimodal, bimodal, or trimodal HDPE, ULDPE, LLDPE, and LDPE; Metallocene LLDPE and random, block, and homo copolymer PP. The mineral filler can advantageously comprise calcium carbonate, dolomite, magnesium silicate, and clay.

Monolayer film samples were produced using a wide range of recipes with a range of film thickness varying from 12 to 200 microns. Multilayer film samples were also produced using a co-extruded three-layer structure (A/B/C) with total film thickness ranging from 18 to 190 microns. In the case of co-extruded films, the layer thickness ranged from 3 microns to 75 microns for skin layers and from 8 microns to 150 microns for center layers.

### DETAILED DESCRIPTION OF THE INVENTION

In brief, then, the ranges of the components of the film of the present invention are as follows:

Polyolefin resin −30 to 95 parts

mineral filler −5 to 70 parts

With respect to the properties of the end product, namely the extruded or cast synthetic plastic film, the following Table I lists the “broad” range and “specific” range for material property requirements, with the “specific” range being especially suitable for non-ghosting masking synthetic plastic films:

TABLE 1
Performance Ranges of Non-Ghosting Films

| | | | |
|---|---|---|---|
| Unit: | Blend 1 | Blend 2 | Blend 3 |

Specimen: 25 mm × 100 mm(25 micron film)

| | | | | |
|---|---|---|---|---|
| Weight per meter | Gram | 53.2 | 55.3 | 53.6 |
| Tensile strength | Newton | | | |
| TD | | 11.4 | 12.9 | 13.7 |
| MD | | 15.2 | 14.9 | 17.5 |
| Elongation | % | | | |
| TD | | 347.6 | 372.7 | 436.5 |
| MD | | 209.5 | 264 | 282.5 |
| Dart Impact F-50 | Gram | 80 | 60 | 100 |
| Tear resistance | MN | | | |
| TD | | 1547 | 1826 | 2901 |
| MD | | 323 | 301 | 290 |

Specimen: 25 mm × 100 mm (30 micron film)

| | | | | |
|---|---|---|---|---|
| Weight per meter | gram | 62.7 | 62.9 | 64.8 |
| Tensile strength | Newton | | | |
| TD | | 16.9 | 15.6 | 15.4 |
| MD | | 18.9 | 18.2 | 19.4 |
| Elongation | % | | | |
| TD | | 492 | 403 | 432 |
| MD | | 268 | 273 | 305 |
| Dart Impact F-50 | gram | 60 | 80 | 100 |
| Tear resistance | mN | | | |
| TD | | 2262 | 1768 | 3281.1 |
| MD | | 456 | 436 | 320 |

### COMPARATIVE EXAMPLES 1-3

The following Examples are representative of the composition of the coextruded film of the instant invention. These films are prepared according to the batch compositions described in Table 2, and processed according to the apparatus settings of Table 3. These composition and process parameters are meant to be representative of the settings and characteristics of the process. It is understood that variation in processing parameters can affect film characteristics and performance, however the following are representative. Other settings are possible which may result in a similar product.

TABLE 2
Material Composition of Representative Synthetic Plastic Films:

| | | |
|---|---|---|
| Blend 1 | Blend 2 | Blend 3 |

25 micron film, lay flat width = 100.4 cm
BUR: 4.6
Density: 1.05 gr/cc

| | | | | |
|---|---|---|---|---|
| Screw 1: | 6.25 | 50% Unimodal | 50% Unimodal | 50% Unimodal |
| | micron | HDPE | HDPE | HDPE |
| | | 40% PaperFIN | 40% PaperFIN | 30% PaperFIN |
| | | Compound | Compound | Compound |
| | | Grade 4 | Grade 4 | Grade 4 |
| | | 10% LCC | 10% LCC | 20% LCC |
| | | 80 W | 80 W | 80 W |
| | Dosing: | 0.5% Resolve | 0.5% Resolve | 0.5% Resolve |
| Screw 2: | 12.5 | 60% Bimodal | 70% Bimodal | 75% Bimodal |
| | micron | HDPE | HDPE | HDPE |
| | | 20% PaperFIN | 20% PaperFIN | 25% LCC |
| | | Compound | Grade 4 | 80 W |
| | | Grade 4 | 10% LCC | |
| | | 20% LCC | 80 W | |
| | | 80 W | | |
| | Dosing: | 0.5% Resolve | 0.5% Resolve | 0.5% Resolve |
| Screw 3: | 6.25 | 50% Unimodal | 50% Unimodal | 50% Unimodal |
| | micron | HDPE | HDPE | HDPE |
| | | 40% PaperFIN | 40% PaperFIN | 30% PaperFIN |
| | | Compound | Compound | Compound |
| | | Grade 4 | Grade 4 | Grade 4 |
| | | 10% LCC | 10% LCC | 20% LCC |
| | | 80 W | 80n W | 80 W |
| | Dosing: | 0.5% Resolve | 0.5% Resolve | 0.5% Resolve |

30 micron film, lay flat width = 100.4 cm
BUR: 4.6
Density: 1.05 gr/cc

| | | | | |
|---|---|---|---|---|
| Screw 1: | 7.5 | 50% Unimodal | 50% HDPE | 50% Unimodal |
| | micron | HDPE | Mobil | HDPE |
| | | 40% PaperFIN | 40% PaperFIN | 30% PaperFIN |
| | | Compound | Compound | Compound |
| | | Grade 4 | Grade 4 | Grade 4 |
| | | 10% LCC | 10% LCC | 20% LCC |
| | | 80 W | 80 W | 80 W |
| | dosing: | 0.5% Resolve | 0.5% Resolve | 0.5% Resolve |
| Screw 2: | 15 | 60% Bimodal | 70% Bimodal | 75% Bimodal |
| | micron | HDPE | HDPE | HDPE |
| | | 20% PaperFIN | 20% PaperFIN | 25% LCC |
| | | Compound | Compound | 80 W |
| | | Grade 4 | Grade 4 | |
| | | 20% LCC | 10% LCC | |
| | | 80 W | 80 W | |
| | dosing: | 0.5% Resolve | 0.5% Resolve | 0.5% Resolve |
| Screw 3: | 7.5 | 50% Unimodal | 50% Unimodal | 50% Unimodal |
| | micron | HDPE | HDPE | HDPE |
| | | 40% PaperFIN | 40% PaperFIN | 30% PaperFIN |
| | | Compound | Compound | Compound |
| | | Grade 4 | Grade 4 | Grade 4 |
| | | 10% LCC | 10% LCC | 20% LCC |
| | | 80 W | 80 W | 80 W |
| | dosing: | 0.5% Resolve | 0.5% Resolve | 0.5% Resolve |

TABLE 3
Parameters for Run of Representative Synthetic Plastic Films

| | Screw 1 | Screw 2 | Screw 3 |
|---|---|---|---|
| 25 micron film | | | |
| Barrel Pressure (psi) | 497 | 466 | 418 |
| Neck Height (cm) | 145 | | |
| Screw Speed (Rpm) | 39 | 57 | 27 |
| Haul off rate (m/min) | 38 | | |
| Melt temperature (° C.) | 204 | 225 | 205 |
| Temperature Setting (° C.) | | | |
| Barrel 1 (feed zone) | 200 | 200 | 200 |
| Barrel 2 | 200 | 200 | 200 |
| Barrel 3 | 200 | 200 | 200 |
| Barrel 4 | 200 | 200 | 200 |
| Adapter | 200 | 200 | 200 |
| die; | 200-200-200-200 | | |
| 30 micron film | | | |
| Barrel Pressure (psi) | 497 | 466 | 418 |
| Neck Height (cm) | 148 | | |
| Screw Speed (Rpm) | 38 | 53 | 27 |
| Haul off rate (m/min) | 32 | | |
| Melt temperature (° C.) | 204 | 222 | 205 |
| Temperature Setting (° C.*) | | | |
| Barrel 1 (feed zone) | 200 | 200 | 200 |
| Barrel 2 | 200 | 200 | 200 |
| Barrel 3 | 200 | 200 | 200 |
| Barrel 4 | 200 | 200 | 200 |
| Adaptor | 200 | 200 | 200 |

| | |
|---|---|
| die; | 200-200-200-200 |

*Note:
Fine adjustment of all temperature figures can be set within the range of +/− 10° C.

### EXAMPLE 1

The typical thickness and thickness configuration for 3 layer film at given total thickness

Balanced Structure.

18 um, A/B/C, 3 um/12 um/3 um, 4 um/10 um/4 um, 4.5 um/9 um/4.5 um.

20 um, A/B/C, 3 um/14 um/3 um, 4 um/12 um/4 um, 4.5 um/11 um/4.5 um.

25 um, A/B/C, 6.25 um/12.5 um/6.25 um

28UM, A/B/C, 3 um/22 um/3 um, 4 um/20 um/4 um, 4.5 um/19 um/4.5 um.

28 um, A/B/C, 6 um/16 um/6 um, 7 um/14 um/7 um, 8 um/12 um/8 um.

30 um, A/B/C, 7 um/16 um/7 um, 7.5 um/15 um/7.5 um

Imbalanced Structure

Typical Examples:

28 um, A/B/C, 6 um/15 um/7 um, 5 um/14 um/9 um.

30 um, A/B/C, 6 um/17 um/7 um, 5 um/16 um/9 um.

### EXAMPLE 2

In the case of 5 layers the structure can be as follows:

5 layers.

A/B/C/B/D, where B is the typical tie layer to bond materials of different natures and compatibility. Bonding layer can range from 2 to 10 microns depending on the mix and the desired property required.

A,C,D layers can range in thickness from 3 to 125 microns each.

### EXAMPLE 3

7 layers.

Balanced Structure:

A/B/C/D/C/B/A. Where B and D are different types of adhesive layers for different materials. Film layer thickness ranges from 2 to 10 microns depending on the mix and desired property required.

A,C layers can range in thickness from 3 to 125 microns each.

Imbalanced Structure.

A/B/C/D/F/G/H, where B,D,G are different types of adhesive layer for different materials. Thickness ranges from 2 to 10 microns.

A,C,F,H are materials of different natures and characteristics. Thickness of each layer ranges from 3 to 125 microns each.

### EXAMPLE 4

Synthetic plastic films containing mineral filler with particle size exceeding 3 μ are compared with commercially available plastic films, and commercially available plastic films which are processed with patterning or embossing in a trapped water test. Painted test panels are prepared. One drop of water is placed on each panel and then the panel is covered with a piece of test film. The edges are then sealed with plastic tape. The panels are baked at 135° F. for two hours.

The results show that the commercially available patterned or embossed film maintains less intimate contact with the painted surface and exhibits reduced staining when compared with non-patterned commercially available film. However, the patterning or embossing is visible in the painted surface. The panel covered with the synthetic plastic films of the instant invention containing the large particle size mineral filler exhibits even less staining or ghosting than the patterned commercially available film, and there was no evidence of patterning.

It is thereby seen from the foregoing that the objects of the present invention have been accomplished. A novel, efficient, economic, and superior synthetic plastic film, having decided advantages in application or use as a masking material and as a protectant, has been provided, all in accord with the Objects of the Invention and the Summary of the Invention set forth hereinbefore.

It is to be understood that the present invention is not to be limited to the exact details of operation, or to the exact compounds, compositions, methods, procedures, or embodiments shown and described, as various modifications and equivalents will be apparent to one skilled in the art, wherefore the present invention is to be limited only by the full scope which can be legally accorded the appended claims.

We claim:

1- A synthetic plastic film of one or more layers particularly suitable for masking or protecting a painted surface without causing staining or ghosting, comprising a polyolefin carrier resin and at least 5 percent by weight of a mineral filler, wherein the mineral filler has a particle size of at least 3 microns, which film can be generated by a blown or cast method at high speeds.

2- A synthetic plastic film of claim 1 wherein the polyolefin carrier resin consists of at least one polyolefin which is a linear or branched alpha olefin with a molecular weight of between 1000 and 1000000.

3- A synthetic plastic film of claim 1 wherein the polyolefin carrier resin is selected from the group consisting of LDPE, LLDPE, MDPE, HDPE, Metallocene LLDPE, random copolymer PP, block copolymer PP, and homopolymer PP.

4- A synthetic plastic film of claim 1 wherein the polyolefin carrier resin may be a single polyolefin or a blend of two or more polyolefins.

5- A synthetic plastic film of claim 1 wherein the mineral filler is selected from the group consisting of calcium carbonate, dolomite, magnesium silicate, and clay.

6- A calcium carbonate mineral filler of claim 5 which contains calcium carbonate, magnesium carbonate, and iron carbonate.

7- A dolomite mineral filler of claim 5 which contains calcium carbonate, magnesium carbonate, aluminum carbonate, and iron carbonate.

8- A magnesium silicate mineral filler of claim 5 which contains silicon oxide, magnesium oxide, iron oxide, and calcium oxide.

9- A clay mineral filler of claim 5 which contains aluminum oxide, silicon oxide, magnesium oxide, potassium oxide, sodium oxide, and iron oxide.

10- A synthetic plastic film of claim 1 wherein the mineral filler comprises up to 5 percent by weight of the total film weight.

11- A synthetic plastic film of claim 1 wherein the mineral filler comprises up to 10 percent by weight of the total film weight.

12- A synthetic plastic film of claim 1 wherein the mineral filler comprises up to 20 percent by weight of the total film weight.

13- A synthetic plastic film of claim 1 wherein the mineral filler comprises up to 40 percent by weight of the total film weight.

14- A synthetic plastic film of claim 1 wherein the mineral filler comprises up to 60 percent by weight of the total film weight.

15- A synthetic plastic film of claim 1 wherein the mineral filler particle size is up to 30 percent of the total film thickness.

16- A synthetic plastic film of claim 1 wherein the mineral filler particle size is up to 40 percent of the total film thickness.

17- A synthetic plastic film of claim 1 wherein the mineral filler particle size is up to 50 percent of the total film thickness.

18- A synthetic plastic film of claim 1 wherein a multilayer film is coextruded.

19- A multilayer film of claim 18 which consists of three layers.

20- A multilayer film of claim 18 which consists of five layers.

21- A multilayer film of claim 18 which consists of seven layers.

22- A multilayer film of claim 18 wherein each layer may have a different formulation, and wherein each layer may have a different thickness.

23- A multilayer film of claim 18 in which the synthetic plastic film is coextruded with a conductive material.

24- A multilayer film of claim 18 in which the synthetic plastic film is coextruded with an antistatic material.

25- A multilayer film of claim 18 in which the synthetic plastic film is coextruded with a flame-retardant material.

26- A multilayer film of claim 18 in which the synthetic plastic film is coextruded with a colorant.

27- A multilayer film of claim 18 in which the synthetic plastic film is coextruded with a matte paperlike resin composition.

28- A multilayer film of claim 18 in which the synthetic plastic film is coextruded with a synthetic paper composition.

29- A synthetic plastic film of claim 1 wherein a monolayer film is extruded.

30- A multilayer film of claim 18 in which the synthetic plastic film is coextruded with a styrene butadiene copolymer.

31- A multilayer film of claim 18 in which the synthetic plastic film is coextruded with a polyamide 6 and/or 6.6 and/or 12.

32- A synthetic plastic film of claim 1 that, when applied to a painted surface protects against paint overspray without staining or ghosting the painted surface and without leaving a pattern on the painted surface.

33- A synthetic plastic film of claim 1 that, when applied to a painted surface protects against moisture and ultraviolet damage to the painted surface without staining or ghosting the surface and without leaving a pattern on the surface.
